(19) United States
(12) Patent Application Publication
(10) Pub. No.: US 2025/0271894 A1
(43) Pub. Date: Aug. 28, 2025

(54) SYSTEM TIME CLOCK SYNCHRONIZATION ON AN SOC WITH LSB SAMPLING

(71) Applicant: Akeana, Inc., Santa Clara, CA (US)

(72) Inventor: Yogesh Shamkant Thombre, Pleasanton, CA (US)

(73) Assignee: Akeana, Inc., Santa Clara, CA (US)

(21) Appl. No.: 19/059,356

(22) Filed: Feb. 21, 2025

Related U.S. Application Data
(60) Provisional application No. 63/745,432, filed on Jan. 15, 2025.
(60) Provisional application No. 63/735,937, filed on Dec. 19, 2024.
(60) Provisional application No. 63/730,997, filed on Dec. 12, 2024.
(60) Provisional application No. 63/702,192, filed on Oct. 2, 2024.
(60) Provisional application No. 63/699,245, filed on Sep. 26, 2024.
(60) Provisional application No. 63/691,351, filed on Sep. 6, 2024.
(60) Provisional application No. 63/690,822, filed on Sep. 5, 2024.
(60) Provisional application No. 63/687,795, filed on Aug. 28, 2024.
(60) Provisional application No. 63/679,685, filed on Aug. 6, 2024.
(60) Provisional application No. 63/679,192, filed on Aug. 5, 2024.
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/714,529, filed on Oct. 31, 2024.
(60) Provisional application No. 63/719,841, filed on Nov. 13, 2024.

(51) Int. Cl. G06F 1/12; G06F 15/78

(52) U.S. Cl. CPC G06F 1/12; G06F 15/7814

(57) ABSTRACT

Techniques for managing a system time clock within a processor are disclosed. A system-on-a-chip (SOC) is accessed. The SOC includes a system timer and one or more compute clusters. Each compute cluster includes one or more processors. Each processor includes an internal processor clock. The system timer generates a timer count based on a system timer clock. The timer clock is slower than every processor clock. The system timer count is sent to each compute cluster. The timer count is distributed by clusters to processors. Sampling logic is triggered within a first processor, based on a system timer count least significant bit (LSB) state change. Sampling logic within each processor samples the system timer count. The sampling occurs after a minimum of two cycles of each processor clock, following the triggering. The sampling obtains a current value of the system timer count.

### RELATED APPLICATIONS

This application claims the benefit of U.S. provisional patent applications “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563,102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, and “Non-Flushing Vector Micro-Operations With VSET” Ser. No. 63/745,432, filed Jan. 15, 2025.

Each of the foregoing applications is hereby incorporated by reference in its entirety.

### FIELD OF ART

This application relates generally to synchronization and more particularly to system time clock synchronization on an SOC with LSB sampling.

### BACKGROUND

Computer processors are found in nearly all electronic devices widely used throughout society. Processors enable electronic device utility and support many industries and applications. They have revolutionized how people work, play, communicate, and access information. Processors underpin computing devices including computers, laptops, tablets, and smartphones, and enable internet browsing, application execution, content access, data processing, and communication. The processors are embedded in smart devices, sensors, and appliances to enable connectivity and data processing, and have spurred growth of the Internet of Things. The processors collect, analyze, and transmit data, supporting automation, remote monitoring, and control of systems including smart homes, industrial automation, healthcare devices, vehicles, and more. Electronic devices enable communication and networking technologies and are found in routers, switches, and modems, facilitating data transmission and network management. The processors are also used in telecommunications infrastructure, mobile network equipment, and wireless devices, providing seamless connectivity and communication. The processors are present in a wide array of consumer electronics beyond computers and smartphones. They are found in televisions, gaming consoles, digital cameras, home appliances, audio systems, wearables, and more. The processors enable advanced features, user interfaces, and connectivity options in these consumer devices. Processor versatility, scalability, and computational power have transformed various industries, driving innovation and promoting technology advancements in numerous domains.

The two general categories of processors include Complex Instruction Set Computer (CISC) types, and Reduced Instruction Set Computer (RISC) types. In a CISC processor, one instruction typically executes several operations. The operations can include memory storage, memory loading, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Electronic devices based on integrated circuits (ICs) are usually designed using a Hardware Description Language (HDL). Examples of such languages include Verilog, VHDL, and processor-specific languages. HDLs enable abstract descriptions of behavioral, register transfer, gate, and switch level logic. The languages provide designers with the ability to define systems and varying levels of detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program, to test the logic design. Part of the process may include Register Level Transfer (RTL) abstractions that define the synthesizable data that is fed into a logic synthesis tool which in turn creates the gate-level abstraction of the design that is used for downstream implementation operations.

### SUMMARY

Disclosed techniques include system time clock synchronization on an SOC with LSB sampling. The system time clock synchronization is enabled across one or more processors, one or more compute clusters of processors, and so on. A system-on-a-chip (SOC) is accessed. The SOC can be based on one of a plurality of integrated circuit technologies. In order to enable synchronization across the SOC, the SOC includes a system timer and one or more compute clusters. Each of the one or more compute clusters includes one or more processors. The processors can include heterogeneous processors, homogeneous processors, multiprocessors, etc. Each of the one or more processors includes an internal processor clock. The internal processor clock within each of the one or more processors can operate at substantially similar frequencies or at different frequencies. A system timer count is generated by a system timer. The system timer count can include a value based on a number of bits such as a 64-bit value. The generating is based on a system timer clock. The system timer clock can include a free-running clock. The system timer clock is slower in frequency than every internal processor clock within the one or more processors within the one or more compute clusters within the SOC. The frequency of the system timer clock conforms to: f<C/4, wherein f is the frequency of the system timer clock and Cis a slowest processor clock within the one or more processors within the one or more compute clusters within the SOC. The system timer count is sent, by the system timer, to each of the one or more compute clusters. The sending can be accomplished using a network such as a network-on-a-chip (NOC). The system timer count is distributed by each of the one or more compute clusters to the one or more processors within the one or more compute clusters. A sampling logic is triggered within a first processor within the one or more processors. The first processor is located within a first compute cluster within the one or more compute clusters. The first processor includes a first processor clock. The triggering is based on a change of state of a least significant bit (LSB) of the system timer count. The change in state can include a change from a logic zero state to a logic one state or a logic one state to a logic zero state. The change can include a rising edge or a falling edge. The system timer count is sampled, by the sampling logic, within the first processor. The sampling occurs after a minimum of two cycles of the first processor clock, following the triggering. The sampling after the minimum two cycles compensates for differing processor clock frequencies, differences in clock signal propagation times, and so on. The sampling obtains a current value of the system timer count. The current value of the system timer count is used for system synchronization.

A processor-implemented method for synchronization is disclosed comprising: accessing a system-on-a-chip (SOC), wherein the SOC includes a system timer and one or more compute clusters, wherein each of the one or more compute clusters includes one or more processors, wherein each of the one or more processors includes an internal processor clock; generating, by the system timer, a system timer count, wherein the generating is based on a system timer clock, and wherein the system timer clock is slower in frequency than every internal processor clock within the one or more processors within the one or more compute clusters within the SOC; sending, by the system timer, to each of the one or more compute clusters, the system timer count; distributing, by each of the one or more compute clusters, the system timer count to the one or more processors within the one or more compute clusters; triggering a sampling logic within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count; and sampling, by the sampling logic within the first processor, the system timer count, wherein the sampling occurs after a minimum of two cycles of the first processor clock, following the triggering, and wherein the sampling obtains a current value of the system timer count. Some embodiments comprise producing a delay_lsb signal, wherein the delay_lsb signal includes buffering, by one or more D flip-flops, the LSB of the system timer count. In embodiments, the one or more D flip-flops are metastable. In embodiments, the sampling logic includes creating a sync_enable signal, wherein the creating includes an XOR logic element, and wherein the sync_enable signal allows the system timer count to be latched by the first processor. Some embodiments comprise determining a frequency of the system timer clock, wherein the frequency of the system timer clock conforms to: f<C/4, wherein f is the frequency of the system timer clock and Cis a slowest processor clock within the one or more processors within the one or more compute clusters within the SOC.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for system time clock synchronization on an SOC with LSB sampling.

FIG. 2 is a flow diagram for sampling a system timer count.

FIG. 3 is a block diagram of a multicore processor.

FIG. 4 is a block diagram of a pipeline.

FIG. 5 is a block diagram of a system timer clock distribution.

FIG. 6 is an example diagram of a system timer clock.

FIG. 7 is a block diagram for sampling with a system timer clock LSB.

FIG. 8 is a block diagram for sampling logic.

FIG. 9 is an example timing diagram for sampling with a system timer clock LSB.

FIG. 10 is a system diagram for system time clock synchronization on an SOC with LSB sampling.

### DETAILED DESCRIPTION

Electronic devices are used daily by individuals worldwide. The variety of electronics is seemingly endless, ranging from small and simple devices to large and complex ones. The electronic devices provide wide-ranging features such as large or small, stationary or portable, powerful or simple, among numerous others. The most popular electronic devices include personal electronic devices such as computers, handheld electronic devices such as smartphones and tablets, and wearable electronic devices such as smartwatches. The electronic devices are also present in household devices including kitchen and cleaning appliances; vehicles for personal, private, and mass transportation; and medical equipment; among many other familiar devices. Each of these devices is constructed with one type or often many types of integrated circuits or chips. The chips enable required, useful, and desirable device features by performing processing and control tasks. Electronic processors enable the devices to execute an extensive range and number of applications. Additional electronic elements can be coupled to the processors in higher-function chips such as system-on-a-chip (SOC) devices. The SOCs consist of processors that are organized in clusters. The processors can perform tasks such that multiple tasks can be performed at substantially the same time. In order for the execution of the multiple processes to succeed, the execution of the processes must be coordinated. The coordination can be accomplished using a clock such as a system clock.

Techniques for system time clock synchronization on an SOC with LSB sampling are described. The system time clock synchronization can be accomplished with a system timer count, which can orchestrate execution of processes on multiple processors within multiple compute clusters. The system timer count can be used to distribute “system time” to the processors within multiple compute clusters. The system timer count can be also used by the processors to carry out timer and counting operations, drive interrupts, counter external events, track performance or time required for specific tasks, enforce communications between processors in the SOC, and so on. In the present disclosure, the system time clock synchronization is accomplished using a specially sampled LSB to capture a system timer count and distributing the system timer count to one or more processors within one or more compute clusters. The distributing is accomplished without the need to convert a binary code representing the system timer count to Gray code prior to the distributing. Traditionally, the binary code was converted to the Gray code representation prior to distribution, then converted from the Gray code representation back to the binary representation within each processor. This conversion was necessary to ensure that only one bit of a bus transitioned state at a time, limiting noise and enhancing reliability, especially in long wires. However, this conversion requires additional logic to encode (binary to Gray code) and decode (Gray code to binary). In contrast, the present disclosure enables the distribution of a system timer count to processors within the SOC without the conversion steps. Avoiding conversion of the binary code to Gray code and back to binary code reduces processing overhead while maintaining system timer count integrity.

Methods for synchronization are disclosed. A system-on-a-chip (SOC) can be accessed. The SOC can include a system timer and one or more compute clusters. Each of the one or more compute clusters includes one or more processors. The system timer can be used to orchestrate operations between compute clusters, between processors within the compute clusters, and so on. The processors can include heterogeneous processors, homogeneous processors, multiprocessors, and so on. Each of the one or more processors includes an internal processor clock. The processor clock operates at a rate or frequency. The processor clock frequencies can be substantially similar or different among the processors. The system timer generates a system timer count. The system timer count that is generated can be based on a system timer clock. The system timer clock can operate at a given frequency. The system timer clock is slower in frequency than every internal processor clock within the one or more processors within the one or more compute clusters within the SOC. The system timer clock frequency can be determined based on the frequencies of the internal processor clocks. The frequency of the system timer clock conforms to: f<C/4, wherein f is the frequency of the system timer clock and Cis a slowest processor clock within the one or more processors within the one or more compute clusters within the SOC. The system timer count is sent by the system timer to each of the one or more compute clusters. The sending can be accomplished using a networking technique such as a network-on-chip (NOC) technique. The system timer count is distributed by each of the one or more compute clusters to the one or more processors within the one or more compute clusters. A sampling logic is triggered within a first processor within the one or more processors, wherein the first processor is within a first compute cluster within the one or more compute clusters, wherein the first processor includes a first processor clock, and wherein the triggering is based on a change of state of a least significant bit (LSB) of the system timer count. The system timer count is sampled by the sampling logic within the first processor, wherein the sampling occurs after a minimum of two cycles of the first processor clock, following the triggering, and wherein the sampling obtains a current value of the system timer count.

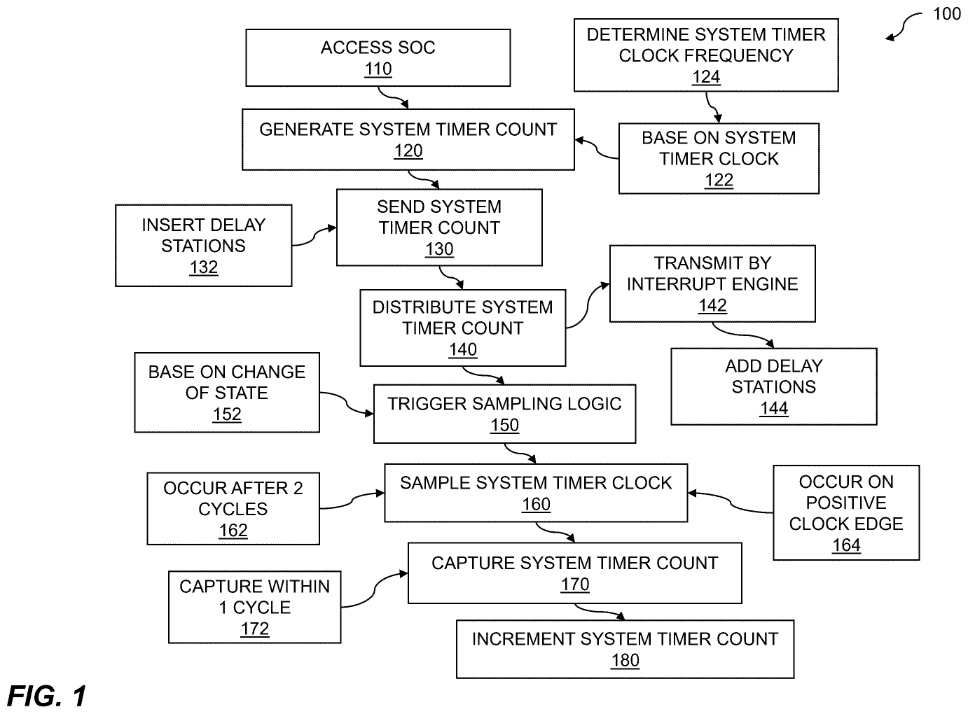

FIG. 1 is a flow diagram for system time clock synchronization on an SOC with LSB sampling. The system time clock synchronization can be used to synchronize local copies of a system timer count. The system timer count can represent system time across a system that includes compute clusters, where each compute cluster can include one or more processors. The compute clusters and/or processors can be organized or configured in a mesh topology. Communication between compute clusters, processors within the compute clusters, and so on can be enabled using communication techniques. The communication techniques can include a network-on-a-chip (NOC) technique. Further elements associated with the SOC can include one or more of multicore processors, physical memory protection (PMP) elements, memory management (MMU) elements, level 1 (L1) caches such as instruction caches and data caches, level 2 (L2) caches, and the like. The one or more processors can further include a level 3 (L3) cache, test and debug support such as Joint Test Action Group (JTAG) elements, a platform-level interrupt controller (PLIC), an advanced core local interrupter (ACLINT), and so on. In addition to the elements just described, the processors within the compute clusters can include one or more interfaces. The interfaces can include one or more industry standard interfaces, interfaces specific to the multicore processor, and the like. In embodiments, the interfaces can include an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. The interfaces can enable connection between the compute clusters and the processors and an interconnect. In embodiments, the interconnect can include an AXI™ interconnect. The interconnect can enable the compute cluster and processor to access a variety of elements such as storage elements, communication elements, peripherals, memory mapped input/output elements, etc.

The flow 100 includes accessing a system-on-a-chip (SOC) 110. The SOC comprises a plurality of elements that enable the sharing of data. The SOC includes a system timer and one or more compute clusters. The system timer can be used to coordinate operations between the compute clusters. Each of the one or more compute clusters includes one or more processors. The processors can include homogeneous processors, heterogeneous processors, multicore processors, and so on. Each of the one or more processors includes an internal processor clock. The internal processor clock can be used to orchestrate execution of processes on the one or more processors. The SOC can include a network-on-a-chip (NOC). The NOC can be organized in a mesh topology such as an M×N mesh. The SOC can include further elements, such as local memory, memory interfaces, secondary memory interfaces, and so on, to enable the sharing of data. The SOC can further include elements such as communication components, graphics processors, network-on-a-chip (NOC) connectivity, etc. The SOC can be based on one or more chips, FPGAs, ASICs, etc. In embodiments, the processors associated with the SOC can include RISC-V™ processor cores. Memory such as local memory within the SOCs includes a local cache. The local cache can include a shared local cache. The shared local cache that can be colocated with other elements associated with the SOC, can be accessible by a processor within the SOC, and so on. The processors can implement special cache coherency operations. The cache coherency operations can include maintenance operations such as cache maintenance operations (CMOs). The cache coherency operations can include a cache line zeroing operation, a cache line cleaning operation, a cache line flushing operation, a cache line invalidating operation, and so on.

The flow 100 includes generating 120, by the system timer, a system timer count. The system timer count can include an integer value. The system timer count can be represented using various numerical representations such as a binary value, a decimal value, a hexadecimal value, and so on. In the flow 100, the generating is based on a system timer clock 122. The system timer clock can include a counter that includes a number of bits. The counter can be based on a free-running counter element, where counting continues while the counter element is enabled. In embodiments, the system timer count can include a 64-bit value. The system timer count can also include a 32-bit value, a 128-bit value, etc. The system timer count can be updated. Embodiments can include incrementing the system timer count, decrementing the system timer count, etc. The system timer can further be set, reset, and so on. The system timer clock is slower in frequency than every internal processor clock within the one or more processors within the one or more compute clusters within the SOC. The slower frequency system time clock can accommodate differing internal processor clock speeds, differing signal propagation times, and the like. The system timer clock frequency can be determined 124. The flow 100 further includes determining a frequency of the system timer clock. The system timer clock can be determined based on one or more frequencies associated with the internal processor clock speeds. In embodiments, the frequency of the system timer clock conforms to: f<C/4, wherein f is the frequency of the system timer clock and Cis a slowest processor clock within the one or more processors within the one or more compute clusters within the SOC.

The flow 100 includes sending 130, by the system timer, to each of the one or more compute clusters, the system timer count. The sending can be accomplished using an interconnect such as a shared bus or other sending technique within the SOC. The sending can be accomplished using one or more networking techniques. In embodiments, the sending is accomplished using a network-on-a-chip (NOC), where the NOC is included in the SOC, accessible to the SOC, and so on. The NOC can accommodate network communications between processors within a compute cluster, between compute clusters, and so on. The NOC can include an M×N mesh topology, which can include a tile such as a coherent tile at each point of the M×N mesh topology. In embodiments, the system timer count is sent in a binary format. This sending differs from traditional techniques that require the binary code to be converted from a binary format to a Gray code. The Gray code format was then reconverted back to the binary format. The method described herein obviates the need for the two conversions by relying on a change of state of a least significant bit (LSB) of the system timer count (described below). The flow 100 further includes inserting one or more delay stations 132. The delay stations can be used to introduce delay into sending the system timer count to a single compute cluster, a subset of compute clusters, and so on. The delay stations can be used to coordinate arrival of the timer count at the compute clusters. The timer count is then distributed to the processors within the compute clusters. In embodiments, the one or more delay stations can include a D flip-flop. The D flip-flop can be based on various circuit topologies that can be used to implement one or more D flip-flops. The D flip-flops can include static circuit topologies, dynamic circuit topologies, and so on. In embodiments, the one or more D flip-flops can be metastable. A metastable D flip-flop can remain in a metastable state (e.g., neither a zero nor a one) until an enabling signal is provided to the D flip-flop. The enabling signal can cause the D Flip-flop to transition to a zero state or a one state.

The system timer count, having been received by the compute clusters, can be provided to the one or more processors within each compute cluster. The flow 100 includes distributing 140, by each of the one or more compute clusters, the system timer count to the one or more processors within the one or more compute clusters. The system timer count can be distributed using one or more buses, an NOC, and so on. Other distribution techniques can be used. In embodiments, the one or more compute clusters include an interrupt engine. The interrupt engine can generate interrupts, where the interrupts can be sent from the compute clusters to an element such as an interrupt handler associated with the SOC. The interrupt engine can be used to send one or more interrupts to one or more processors within a compute cluster. In a usage example, the interrupt engine can send an interrupt to the one or more processors with a compute cluster indicating that system timer count is ready to be distributed. An interrupt can include various flags, semaphores, control signals, and so on. The flow 100 includes transmitting 142, by the interrupt engine, the system timer count to the one or more processors in the first compute cluster. The interrupt engine can interrupt execution by the one or more processors within the first compute cluster while the system timer count is distributed to the processors. Since the distributing the system timer count can encounter various delays associated with the processors, one or more delays may be added to compensate for the various propagation and distributing delays. In the flow 100, the transmitting includes adding 144 one or more delay stations. The delay stations can be used to coordinate arrival of the timer count distributed to the processors within the compute clusters. In embodiments, the one or more delay stations can include a D flip-flop. Various circuit topologies can be used to implement one or more D flip-flops. In embodiments, the one or more additional D Flip-flops can be metastable.

The flow 100 includes triggering 150 a sampling logic within a first processor within the one or more processors. The sampling logic can be enabled to sample the system timer count that was distributed by each of the one or more compute clusters to the one or more processors within the compute clusters. Recall that the processors can include heterogeneous processors, homogeneous processors, processor cores, and so on. The first processor is located within a first compute cluster within the one or more compute clusters. The processors can have substantially similar clock frequencies or substantially dissimilar clock frequencies. The first processor includes a first processor clock. The frequency associated with the first processor clock is a frequency appropriate to the first processor, and not necessarily the same clock frequency as other processors, when present, within the same compute cluster. The first processor clock can be significantly higher than the system timer clock. In embodiments, the first processor clock frequency is at least four times the system timer clock frequency. The triggering can be accomplished using a flag, a semaphore, a control signal, and so on. In the flow 100, the triggering is based on a change of state 152 of a least significant bit (LSB) of the system timer count. The change in state of the LSB can include a change from a logic zero value to a logic one value, or a one value to a zero value. The changing state can be associated with a rising edge of the LSB or a falling edge of the LSB. Embodiments can include producing a delay_lsb signal, wherein the delay_lsb signal includes buffering, by one or more D flip-flops, the LSB of the system timer count. The delay can be used for synchronization, retiming, LSB signal integrity restoration, etc. The D flip-flops can be based on one or more circuit topologies. In embodiments, the one or more D Flip-flops can be metastable.

The flow 100 includes sampling 160, by the sampling logic within the first processor, the system timer count. The system timer count can be sampled from an interconnect within the compute cluster, from a bus, from the NOC, and so on. Recall that the frequency of the system timer clock is different from the frequency of the first processor clock. Further, the system timer count needs to be distributed to each processor within a compute cloud. Thus, the sampling within the first processor of the system timer count can occur after a minimum number of cycles of the first processor clock. In the flow 100, the sampling occurs after a minimum of two cycles 162 of the first processor clock, following the triggering, wherein the sampling obtains a current value of the system timer count. The minimum number of cycles can be based on signal propagation delays, setup and hold times, and so on. The sampling can occur on a clock edge associated with the first processor clock. In the flow 100, the sampling occurs on a positive clock edge 164 of the first processor clock. In other embodiments, the sampling can occur on a negative clock edge of the first processor clock. One or more elements of the compute cluster can be used for triggering and sampling. In embodiments, the triggering and the sampling can include the interrupt engine. In a usage example, the interrupt engine within a compute cluster receives an interrupt from the SOC. The interrupt engine can cause a processor such as the first processor to suspend process execution and/or to sample the system timer count using the sampling logic.

The flow 100 further includes capturing 170, by every processor within the one or more processors within the one or more compute clusters within the SOC, the system timer count. The capturing the system timer count at each processor can be used to synchronize the processors, coordinate execution of processes across the processors, and so on. The capturing the system timer count can be used to set or reset the system timer count, to update the system timer count, and so on. In the flow 100, the system timer count is captured within one cycle 172 of the system timer clock. The capturing within one cycle of the system timer clock can ensure that the current system timer count is captured by each processor within the one or more processors within the one or more compute clusters within the SOC before the system timer count can be set, reset, or updated. The updating the system timer count can include incrementing the system timer count, decrementing the timer count, etc. The capturing the system timer count within one cycle of the system timer clock enables all of the one or more processors with the compute cluster to operate based on the same system timer count.

The flow 100 further includes incrementing 180 the system timer count. The value associated with the system timer count can be represented by a number of bits. In embodiments, the system timer count can include a 64-bit value. The incrementing the system timer count can include incrementing the LSB of the 64-bit value. The incrementing can be enabled at the SOC level, at a higher level that includes the SOC, and so on. The incrementing can be controlled for execution of a plurality of process distributed across one or more processors within a compute cluster, across one or more compute clusters with the SOC, and so on. The incrementing the system timer count can include decrementing the LSB of the 64-bit value.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

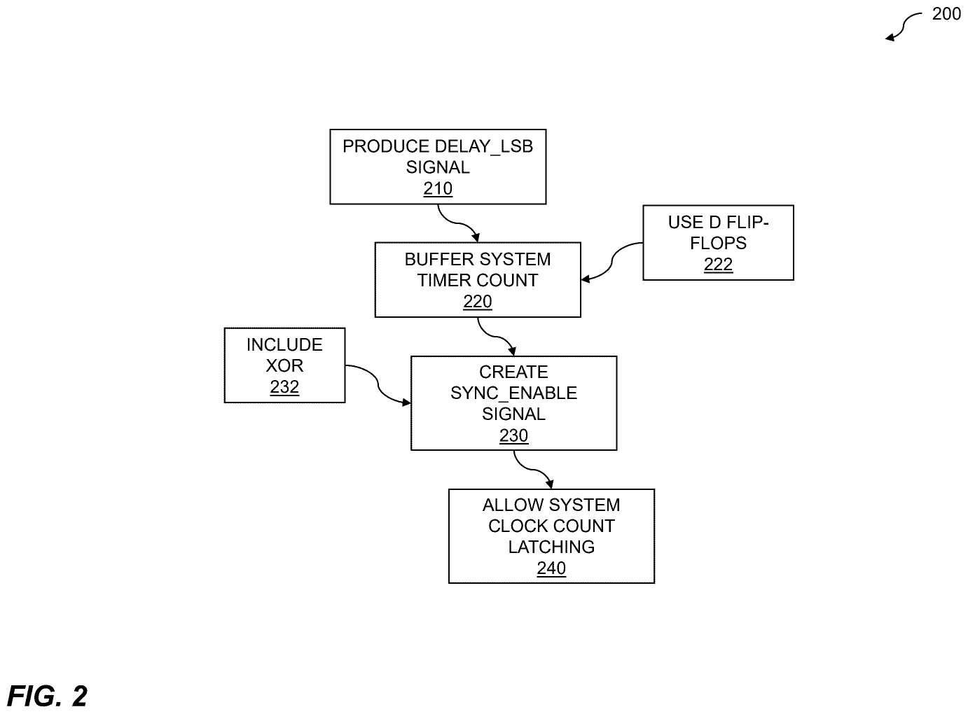

FIG. 2 is a flow diagram for sampling a system timer count. The system timer count is generated by a system timer which is included in a system-on-a-chip (SOC). The system timer generates the system timer count which can be distributed to one or more compute clusters on the SOC. Each compute cluster includes one or more processors. The system timer count can be used within the one or more compute clusters to coordinate execution of various processes by the one or more processors. The system timer count is sampled at each processor within each compute cluster. The sampling the system timer count can be triggered by a change of state of a bit of the system timer count. Sampling the system timer count enables system time clock synchronization on an SOC with LSB sampling.

A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

The flow 200 includes producing a delay_lsb signal 210. The delay_lsb signal can be produced by sampling or reading a least significant bit (LSB) associated with a count. In embodiments, the LSB can include the LSB of the system timer count. The LSB can be delayed, retimed, and so on. The delaying and retiming can be used to balance delivery of the system timer count to the one or more processors within a compute cluster, among compute clusters, and the like. In the flow 200, the delay_lsb signal includes buffering the LSB 220 of the system timer count. The buffering can be accomplished using a stateless buffer circuit such as two series inverters, by a buffer circuit with state such as a flip-flop, etc. In the flow 200, the buffering is accomplished by one or more D flip-flops 222. Various circuit topologies can be used to implement the one or more D flip-flops. In embodiments, the one or more D flip-flops can be metastable. The outputs of the D flip-flops can remain in a metastable state (e.g., neither logic one nor logic zero) until the sampling logic can be triggering. The triggering the sampling logic can be based on the state change of the LSB of the system timer count.

In the flow 200, the sampling logic includes creating 230 a sync_enable signal. The sync_enable signal can enable sampling of the system timer count. The sync_enable signal can be generated using a variety of techniques such as using the local processor clock, an external enable signal, etc. In the flow 200, the creating includes an XOR logic element 232. The XOR element can be used to create the sync_enable signal such that the signal remains valid long enough to enable the sampling, then resets itself. In a usage example, a signal can be delivered to one pin of a two-input XOR logic element. The same signal can be delivered to a second input of the XOR logic element after a delay. Assume that the signal is initially zero, so both inputs to the XOR are zero, resulting in an output of zero. The input signal transitions from zero to one, causing the output of the XOR to transition from zero to one. After a delay, the input signal (a logical one) arrives at the second input to the XOR logic element, causing the output of the XOR to transition from one back to zero. Thus, the duration of the output signal can be maintained at an output of one based on the duration of the delay delivering the input signal to the second input.

In the flow 200, the sync_enable signal allows 240 the system timer count to be latched by the first processor. Similarly, a sync_enable signal can be created in additional processors within a compute cluster, within one or more processors within additional compute clusters, and so on. The latching of the system timer count by the first processor and the latching of the system timer count by additional processors can be used to set a local system timer count within each processor to the system timer count. The timing of the latching of the system timer count must be accomplished within a number of cycles. In embodiments, the sampling can occur after a minimum of two cycles of the first processor clock, following the triggering. The sampling can obtain a current value of the system timer count, which can then be latched.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

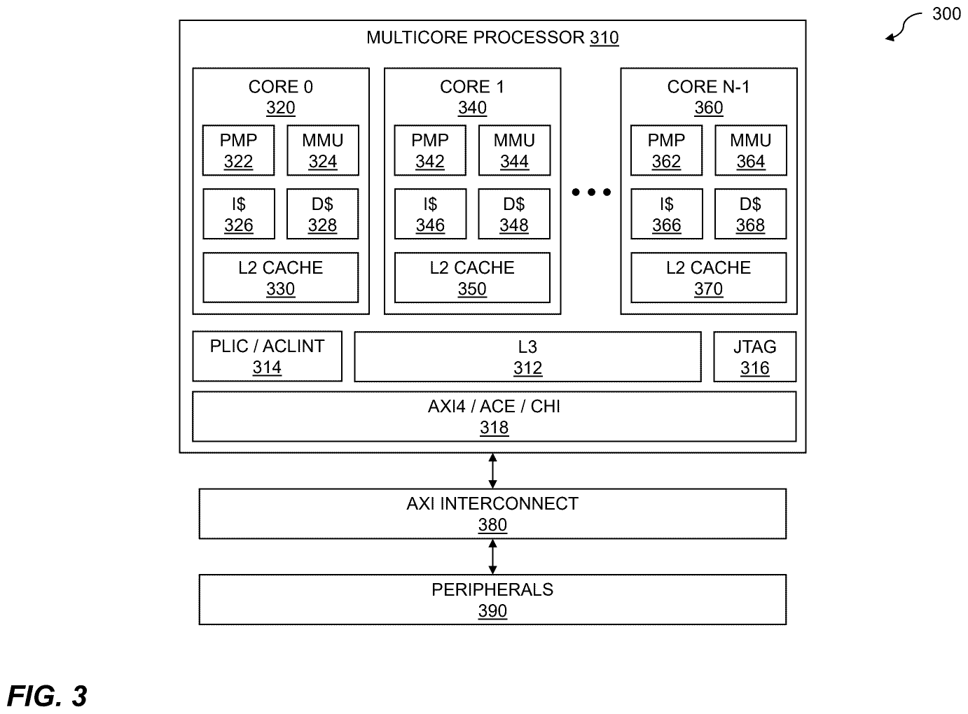

FIG. 3 is a block diagram of a multicore processor. A multicore processor can comprise two or more processor cores, where the processor cores can include homogeneous processor cores or heterogeneous processor cores. The multicore processor can be based on a RISC-V™ processor. The multicore processor can include a variety of elements. The elements can include a plurality of processor cores, one or more caches, memory protection and management units, local storage, communications elements, and so on. The elements of the multicore processor can further include one or more of a private cache, a test interface such as a Joint Test Action Group (JTAG) test interface, one or more interfaces to a network such as a network-on-chip (NoC), a coupling to a common memory structure, peripherals, and the like. The multicore processor is supported by system clock synchronization on an SOC with LSB sampling. A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

The block diagram 300 can include a multicore processor 310. The multicore processor can comprise two or more processors, where the two or more processors can include homogeneous processors, heterogeneous processors, etc. In the block diagram, the multicore processor can include N processor cores such as core 0 320, core 1 340, core N−1 360, and so on. Each processor can comprise one or more elements. In embodiments, each core, including cores 0 through core N−1, can include a physical memory protection (PMP) element, such as PMP 322 for core 0; PMP 342 for core 1, and PMP 362 for core N−1. In a processor architecture such as the RISC-V™ architecture, a PMP can enable processor firmware to specify one or more regions of physical memory such as cache memory of the common memory, and to control permissions to access the regions of physical memory. The cores can include a memory management unit (MMU) such as MMU 324 for core 0, MMU 344 for core 1, and MMU 364 for core N−1. The memory management units can translate virtual addresses used by software running on the cores to physical memory addresses with caches, the common memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$326 and a data cache D$328 associated with core 0; an instruction cache I$346 and a data cache D$348 associated with core 1; and an instruction cache I$366 and a data cache D$368 associated with core N−1. In addition to the level 1 instruction and data caches, each core can include a level 2 (L2) cache. The level 2 caches can include L2 cache 330 associated with core 0, L2 cache 350 associated with core 1, and L2 cache 370 associated with core N−1. Each core associated with multicore processor 310, such as core 0 320 and its associated cache(s), elements, and units, can be “coherency managed” by a compute coherency block (CCB). Each CCB can communicate with other CCBs that comprise the coherency domain. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. The further elements can be unique to a given CCB or can be shared among various CCBs. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced extensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

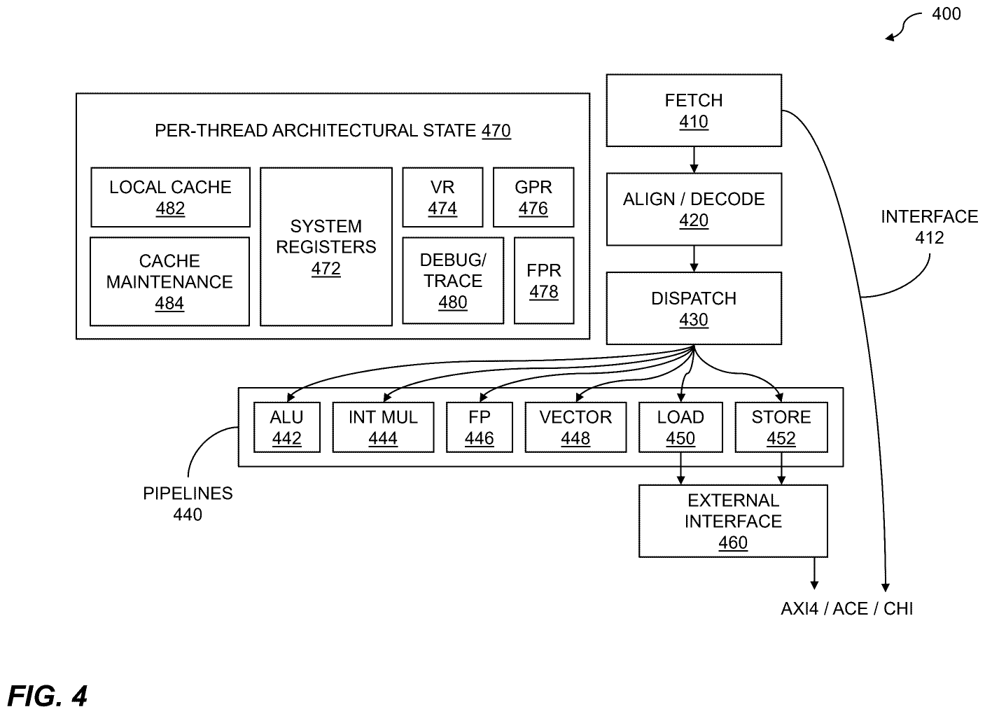

FIG. 4 is a block diagram of a pipeline. One or more pipelines associated with a processor architecture can be used to significantly enhance processing throughput. The processor architecture, such as a multicore processor architecture, can be associated with one or more processor cores, multiprocessors, storage elements, and so on. The processing throughput can be increased by executing two or more operations in parallel. The use of one or more pipelines supports system time clock synchronization on an SOC with LSB sampling. A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

The FIG. 400 shows a block diagram of a pipeline such as a processor core pipeline. The blocks within the block diagram can be configurable in order to provide varying processing levels. The varying processing levels can be based on processing speed, bit lengths, and so on. The block diagram 400 can include a fetch block 410. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, to trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474, general purpose registers (GPR) 476, and floating-point registers (FPR) 478. These registers can be used for vector operations, general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include local cache state 482. The architectural state can include one or more states associated with a local cache, such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

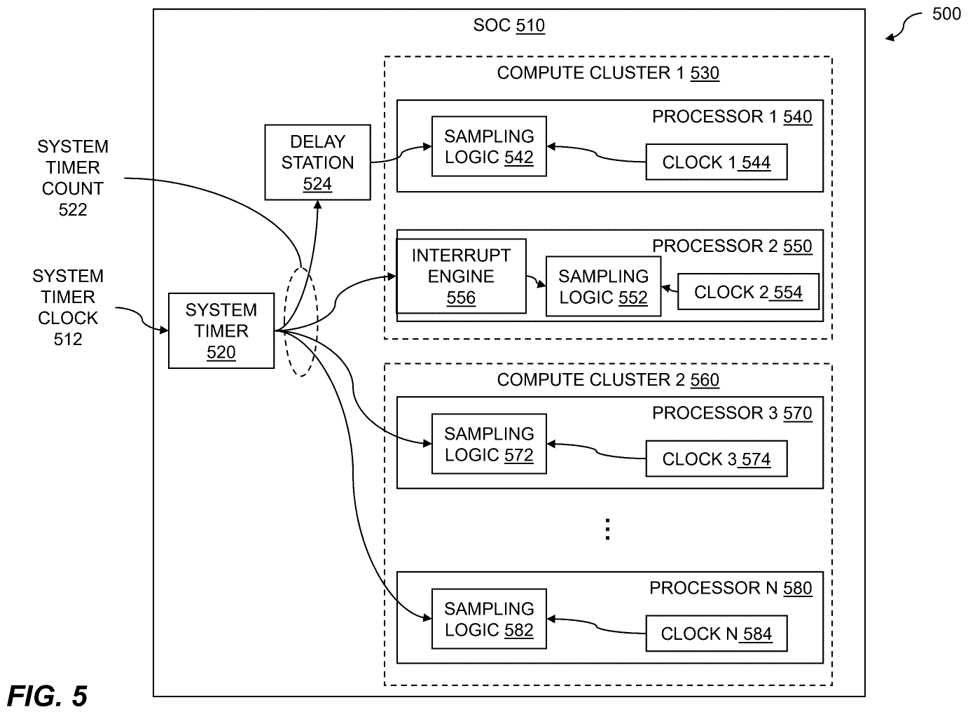

FIG. 5 is a block diagram of a system timer clock distribution. The system timer clock is included in a system-on-a-chip (SOC). The SOC includes one or more compute clusters, where each compute cluster includes one or more processors. The system time clock can be used to orchestrate execution of processes on the one or more processors within the one or more compute clusters. In order for the execution of the processes on the processors to be orchestrated, the system timer clock can be distributed to each of the processors within each of the compute clusters. The orchestration can be based on a state change of one or more bits associated with a system timer count, where the system timer count can be generated by the system timer. The distribution of the system timer clock enables system time clock synchronization on an SOC with LSB sampling. A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

The block diagram 500 includes a system-on-a-chip (SOC) 510. The SOC can include a variety of elements for executing processes, orchestrating process execution, storing data and instructions, and so on. The SOC can receive an input. In the block diagram 500, the input signal can include a system timer clock 512. The system timer clock can be coupled to one or more elements within the SOC. In the block diagram 500, the system timer clock can be coupled to a system timer 520. The system timer can control one or more compute clusters within the SOC, where each compute cluster can include one or more processors. The system timer can generate a system timer count 522. The system timer count can be sent to one or more compute clusters within the SOC. Any number of compute clusters can be included. In the block diagram 500, the compute clusters include compute cluster 1 530 and compute cluster 2 560. Each compute cluster can include one or more processors. Each compute cluster can distribute the system timer count to each processor within the cluster. In the block diagram, compute cluster 1 is shown to include processor 1 540 and processor 2 550. Compute cluster 2 is shown to include processor 3 570, and a number of other processors, up to processor N 580. While two compute clusters are shown, other numbers of compute clusters can be included in the SOC, where each compute cluster can include one or more processors.

The sending to the one or more compute clusters and the distributing the system timer count to the one or more processors within each compute cluster can be accomplished using a variety of techniques. The different techniques can be used to equalize or compensate sending of the system timer count to the one or more compute clusters. The equalizing or compensating techniques can buffer the system timer count, compensate for or equalize propagation delays, and so on. Returning to processor 1 and processor 2 within compute cluster 1, each processor includes sampling logic such as sampling logic 542 and sampling logic 552. Described previously, the sampling logic within each processor can be triggered based on a change of state of a least significant bit (LSB) of the system timer count. Each processor can further include a processor clock such as clock 1 544 within processor 1, and clock 2 554 within processor 2. The processor clocks can have substantially similar frequencies or substantially dissimilar frequencies.

Further embodiments can include inserting one or more delay stations. An example delay station 524 can be inserted between the system timer which is generating the system timer count and a processor within a compute cluster. The delay station can be used to introduce a delay while sending the system timer count to a processor. In embodiments, the one or more delay stations can include a D flip-flop. The D flip-flop can be based on a variety of circuit topologies such as static circuit topologies, dynamic circuit topologies, and so on. In embodiments, the D flip-flops within the one or more delay stations can be metastable. In other embodiments, the one or more compute clusters include an interrupt engine. A compute cluster can be shared by one or more processors with a compute cluster, used by a single processor, and so on. In the block diagram, an interrupt engine 556 is shown in processor 2. In embodiments, the distributing includes the interrupt engine. The interrupt engine can receive an interrupt from the SOC. The interrupt can be based on a change of state, such as the change of state of a least significant bit (LSB) of the system timer count. Further embodiments can include transmitting, by the interrupt engine, the system timer count to the one or more processors in the first compute cluster. The transmitting by the interrupt engine can include a delay. In embodiments, the transmitting includes adding one or more delay stations.

As described previously, the second compute cluster, compute cluster 2, includes one or more processors. In the block diagram 500, compute cluster 2 can include a number, N, of processors including processor 3 570 and processor N 580. While two processors are shown, compute cluster 2 can include other numbers of processors. Each processor can include sampling logic. In the block diagram, processor 3 can include sampling logic 572, and processor N can include sampling logic 582. Each processor within compute cluster 2 can further include a processor clock. The processor clock associated with processor 3 includes clock 3 574, and processor clock associated with processor N includes clock N 584. The sampling logic within processor 3 and within processor N, as with the sampling logic within processor 1 and processor 2, can be based on a change of state of a least significant bit (LSB) of the system timer count.

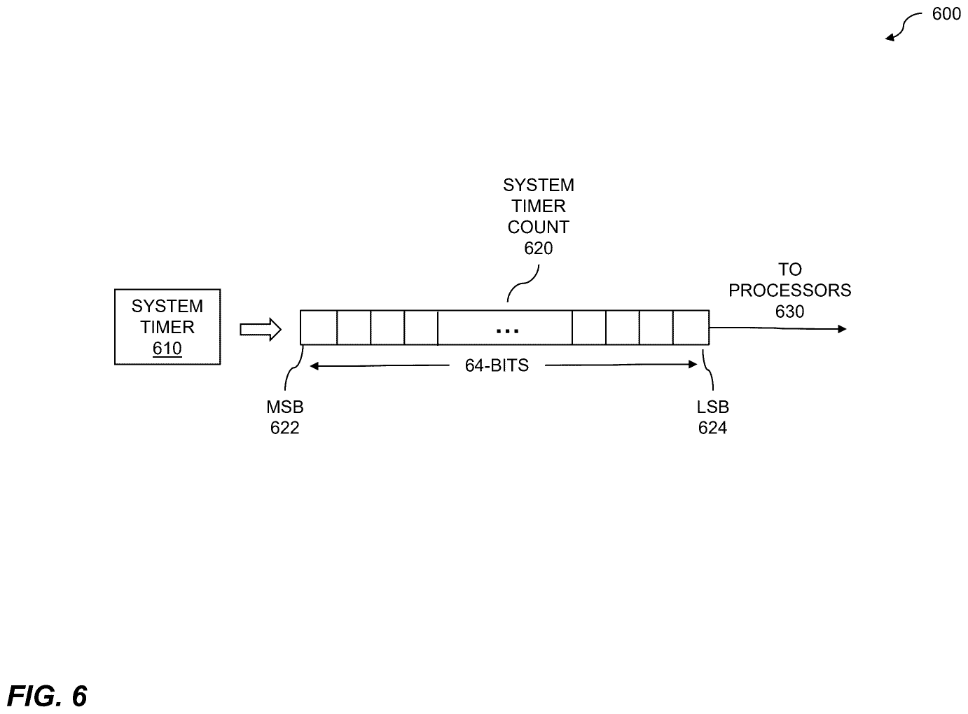

FIG. 6 is an example diagram of a system timer clock. Described previously and throughout, a system timer can be included in a system-on-a-chip (SOC). The system can be used to generate a system timer count. The system timer count can be sent to one or more compute clusters within the SOC. The system timer count is then distributed to one or more processors within each of the compute clusters. The system timer count can be used to orchestrate execution of one or more processes on the one or more processors within a compute cluster, between compute clusters, and so on. The system timer clock enables synchronization on an SOC with LSB sampling. A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

A diagram of a system timer clock 600 is shown. The system timer clock includes a system timer 610. The system timer can be used to generate a value, where the value can be used to orchestrate operations, processes, and so on that can be executed on processors. The processors can include one or more processors within a compute cluster. The compute cluster can be one of one or more compute clusters within the SOC. The system timer can generate a system timer count 620. The system timer count can be represented by a numerical value, where the numerical value can include a binary, decimal, hexadecimal, or other numerical representation. The system timer count can include a number of bits. In embodiments, the system timer count comprises a 64-bit value. Other timer count sizes, such as 128 bits, 256 bits, and so on, can be used. The system timer count can include a “little-endian” representation, where the most significant bit (MSB) 622 is positioned at the left end of the system timer count, and the least significant bit (LSB) 624 is positioned at the right end of the system timer count. The system timer count can increment or decrement its current value based on a trigger from the system timer. Upon reset of the SOC, the system timer count can be reset to zero. The system timer can also reset the system timer count to zero. The system timer count can be transferred to the processors 630. In embodiments, the transferring of the system timer count can be accomplished by sending, by the system timer, to each of the one or more compute clusters, the system timer count. When each of the one or more compute clusters has received the system timer count, the count can be distributed within each compute cluster. Embodiments include distributing, by each of the one or more compute clusters, the system timer count to the one or more processors within the one or more compute clusters. Sampling logic within each processor can be triggered. The triggering can be based on a change of state of a least significant bit (LSB) of the system timer count. The system timer count can be sampled. The sampling can occur after a minimum of two cycles of a processor clock, following the triggering. Embodiments further can include capturing, by every processor within the one or more processors included in the one or more compute clusters within the SOC, the system timer count within one cycle of the system timer clock. The capturing enables each of the one or more processors within each compute cluster to receive the same system timer count.

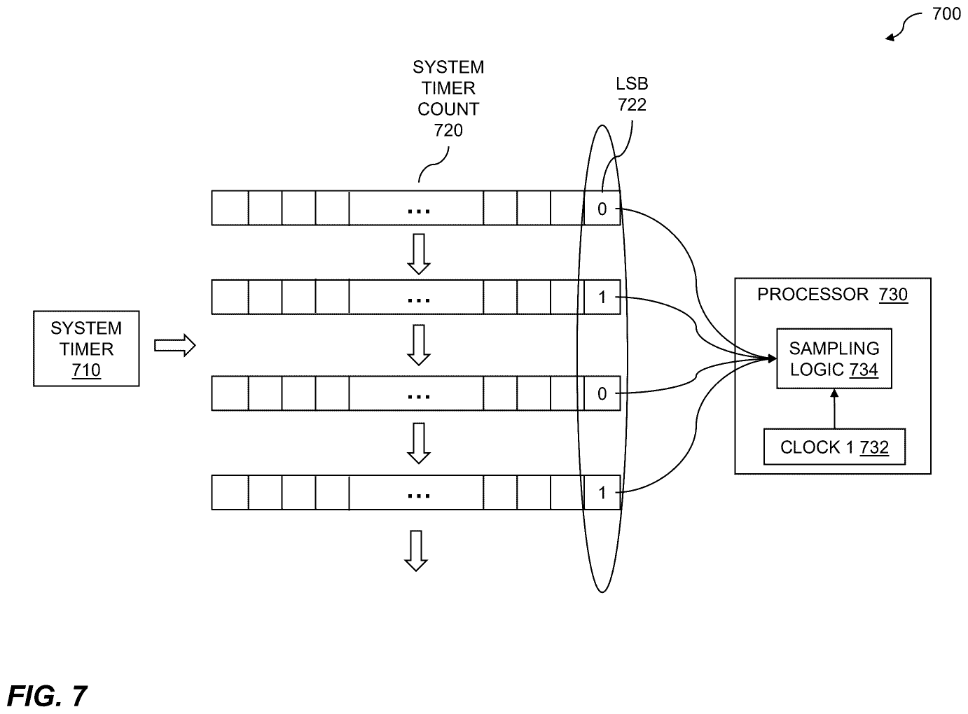

FIG. 7 is a block diagram for sampling with a system timer clock LSB. Sampling logic within a processor can be triggered, where the triggering is based on a state change. The state change can include a state change of a bit associated with a system timer count. Since the least significant bit (LSB) of the system timer count changes most frequently, such as every time the system timer count is incremented, the LSB can be selected and monitored for state changes. A state change of the LSB that triggers the sampling logic within a processor enables the sampling logic to sample the system timer count. The sampling can capture the current system timer count value. Sampling with the system timer clock LSB enables system time clock synchronization on an SOC. A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

The block diagram 700 includes a system timer 710. The system timer can be associated with a system-on-a-chip (SOC) and can be used to orchestrate operations that can be executed on the SOC. Recall that the SOC can include one or more compute clusters, where a compute cluster can include one or more processors. The system timer can be controlled by control logic within the SOC. The system timer can be set, reset, incremented, decremented, and so on. The system timer can include a free-running timer. The system timer includes a system timer count 720. The count can be based on a numerical representation such as a binary representation. The count can include a number of bits. In embodiments, the system timer count can include a 64-bit value. The system timer count includes a least significant bit (LSB) 722. As the system timer count is incremented, the state of the LSB can change. Starting from an LSB value of 0, the LSB can undergo state changes. Three state changes are shown: zero to one, one to zero, and zero to one. The state changes can continue for as long as the system timer count is incremented or otherwise manipulated.

The block diagram 700 includes a processor 730. The processor can include a first processor within a compute cluster, where the compute cluster includes one or more processors. In the block diagram 700, the first processor can include a first internal processor clock 732. The processor clock can operate at a frequency appropriate to the processor. Recall that the processors within a compute cluster can include homogeneous processors, heterogeneous processors, etc. The processor clock frequency is higher than the frequency of the system timer clock. The processor clock frequency can be used to determine the system timer clock frequency. Embodiments can include determining a frequency of the system timer clock, wherein the frequency of the system timer clock conforms to: f<C/4, wherein f is the frequency of the system timer clock and Cis a slowest processor clock within the one or more processors within the one or more compute clusters within the SOC. In the block diagram 700, the first processor includes sampling logic 734. The sampling logic can be used to sample the system timer count. Recall that the sampling can occur after the sampling logic triggering that can result from a change of state of the LSB of the system timer count. The sampling can occur based on one more or more conditions being met. In embodiments, the sampling can occur after a minimum of two cycles of the first processor clock, following the triggering. The minimum of two cycles can enable signal stabilization, interrupt handling, and so on. The sampling can occur on a clock edge of the first processor clock. In embodiments, the sampling can occur on a positive clock edge of the first processor clock. The negative clock edge could also be used. The sampling that is performed by the sampling logic can obtain a current value of the system timer count. In embodiments, the triggering and the sampling can include one or more additional processors within the first compute cluster. By utilizing the sampling logic and the processor clocks within the one or more additional processors within the compute cluster, the current value of the system timer count can be captured by each processor.

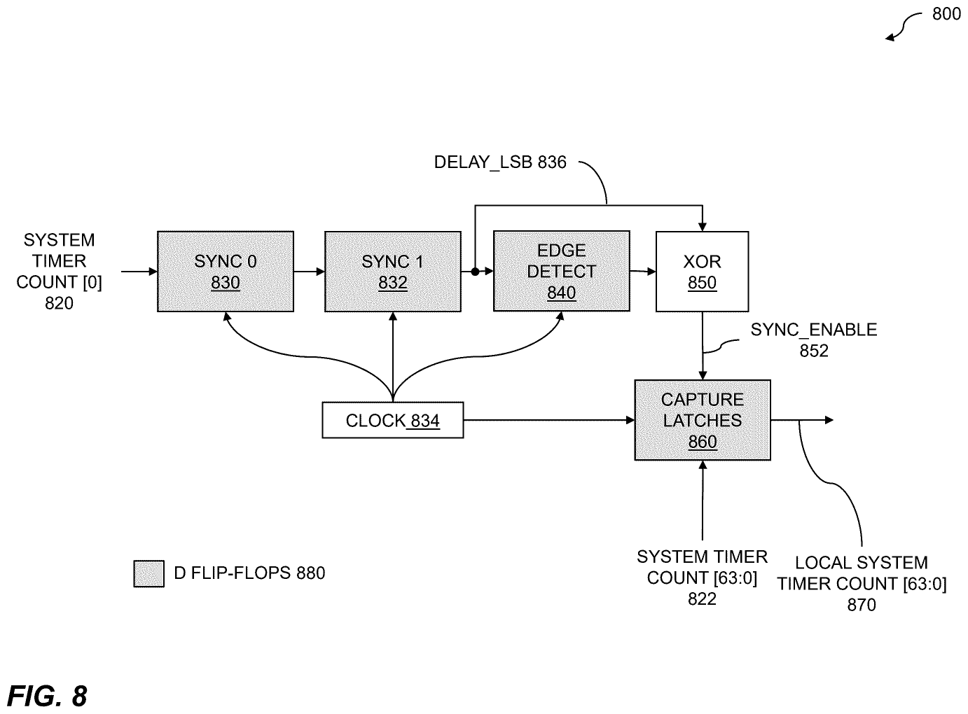

FIG. 8 is a block diagram for sampling logic. Discussed previously, each processor within a compute cluster can include sampling logic. The sampling logic can be used to sample a system timer count, where the system timer count is generated by a system timer. The system timer is included in a system-on-a-chip (SOC) in which the processor is included. The sampling logic within one or more processors within one or more compute clusters is triggered. The triggering initiates sampling of the system timer count by the sampling logic within each processor. The sampling obtains the current value of the system timer count. The system count can be used to synchronize and orchestrate execution of processes on the one or more processors within the one or more compute clusters. The sampling logic enables system time clock synchronization on an SOC with LSB sampling. A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

A block diagram for sampling logic 800 is shown. The sampling logic can be located within a first processor. The first processor can be one of one or more processors within a compute cluster. The sampling logic can include static logic, dynamic logic, metastable logic, and so on. The sampling logic can sample one or more bits associated with a system timer count 820. Recall that the sampling logic within a processor can be triggered by a change of state of a bit associated with the system timer count. In embodiments, the triggering is based on a change of state of a LSB of the system timer count. The LSB includes system_timer_count[0]. The system timer count LSB is provided to one or more stages of synchronization elements. The one or more synchronization elements can include sync 0 830 and sync 1 832. The synchronization elements can accomplish buffering of the system timer count LSB. The synchronization elements can be controlled by a clock 834. The clock can include a processor clock. The processor clock can be included within the processor that includes the sampling logic. Embodiments can further include producing a delay_lsb signal 836. The delay_lsb signal includes buffering, by one or more D flip-flops 880, the LSB of the system timer count. Various types of D flip-flops 880 can be used for the buffering. In embodiments, the one or more D flip-flops 880 are metastable.

The block diagram 800 can include an edge detection element 840. The edge detection element can detect an edge or transition associated with a state transition of the system timer count LSB. An edge can include a positive edge such as a zero to one transition or a negative edge such as a one to zero transition. The output of the edge detector and the delay_lsb signal 836 can be provided to an XOR element 850. Recall that the output of an XOR element or gate is zero when both inputs are substantially similar and zero when the inputs are different. Note also that the edge detector element can impose a delay between the input to the edge detector and the output of the edge detector, effectively delaying the delay_lsb signal. The result is that the XOR output, here labeled sync_enable 852, transitions from zero to one when the delay_lsb signal transitions from zero to one. After the delay introduced by the edge detector, the output of the edge detector transitions from zero to one, thereby causing the output of the XOR to transition from one to zero. The sync_enable signal can be coupled to capture latches 860. The capture latches can capture a number of bits associated with system timer count 822. In embodiments, the system timer count can include a 64-bit value system timer count[63:0]. The capturing by the capture latches can occur on an edge of the sync_enable signal such as a rising edge or a falling edge, while the sync_enable signal is a logic one, and so on. The capturing by the capture latches is also based on an edge such as a positive clock edge of the processor clock 834. Sampling can occur for more than one processor. In embodiments, the triggering by the system timer count LSB and the sampling includes one or more additional processors within a second compute cluster within the one or more compute clusters. Further embodiments can include capturing, by every processor within the one or more processors included in the one or more compute clusters within the SOC, the system timer count within one cycle of the system timer clock. The output of the capture latches, the local system timer count 870, which comprises a 64-bit value, can be stored within the one or more processors. Thus, a copy of the current system timer count is captured in each processor of the one or more processors in a compute cluster. The copy of the current system timer count can also be captured in each of the one or more compute clusters in the SOC.

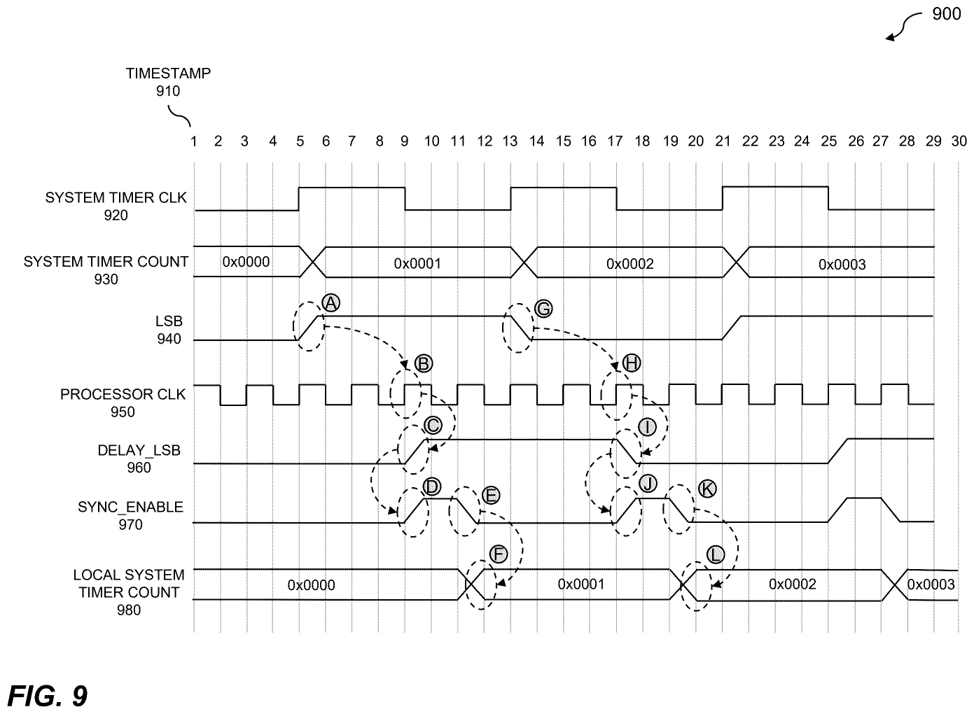

FIG. 9 is an example timing diagram for sampling with a system timer clock LSB. Described above and throughout, the system timer clock can generate a system timer count. The system timer count can be sent to one or more compute clusters within a system-on-a-chip (SOC). The system timer count is then distributed within each compute cluster to each processor within each compute cluster. The system timer clock is sampled within each processor to update a local system timer count within each processor. The sampling is accomplished by sampling logic within one or more processors within each of one or more compute clusters. Since the system timer clock operates at a frequency that is lower than any of the processor clocks within each of the processors, timing constraints must be met in order for each of the processors to obtain the present system timer count. The system timer count can be used within each processor to orchestrate execution of one or more processes. The sampling of the system timer count by each processor can be triggered by a state change of a bit such as the least significant bit (LSB) of the system timer count. The sampling based on the LSB of the system timer count enables system time clock synchronization on an SOC.

A system-on-a-chip (SOC) is accessed, wherein the SOC includes a system timer and one or more compute clusters, wherein each of the one or more compute clusters includes one or more processors, wherein each of the one or more processors includes an internal processor clock. A system timer count is generated by a system timer, wherein the generating is based on a system timer clock, and wherein the system timer clock is slower in frequency than every internal processor clock within the one or more processors within the one or more compute clusters within the SOC. The system timer count is sent, by the system timer, to each of the one or more compute clusters. The system timer count is distributed by each of the one or more compute clusters to the one or more processors within the one or more compute clusters. A sampling logic is triggered within a first processor within the one or more processors, wherein the first processor is within a first compute cluster within the one or more compute clusters, wherein the first processor includes a first processor clock, and wherein the triggering is based on a change of state of a least significant bit (LSB) of the system timer count. The system timer count is sampled, by the sampling logic within the first processor, wherein the sampling occurs after a minimum of two cycles of the first processor clock, following the triggering, and wherein the sampling obtains a current value of the system timer count.

The timing diagram 900 includes a timestamp 910. The timestamp will be used to identify signal transitions such as signal transitions associated with a clock. The signal transitions or edges can include positive (0 to 1) edges and negative (1 to 0) edges. A system timer clock 920 is shown. Recall that the system timer clock operates at a frequency lower than any processor clock, where a processor clock is associated with a processor within a compute cluster. The processor can include one of a plurality of processors. The compute cluster can be one of a plurality of compute clusters within a system-on-a-chip. The frequency of the system timer clock can calculate the processor clock frequencies. Embodiments can include determining a frequency of the system timer clock, wherein the frequency of the system timer clock conforms to: f<C/4, wherein f is the frequency of the system timer clock and Cis a slowest processor clock within the one or more processors included in the one or more compute clusters within the SOC. The system timer clock can generate a system timer count 930. The system timer count can be set, reset, incremented, decremented, etc. In the timing diagram, the system timer count is initially 0x0000. On the rising edge of the system timer clock at timestamp 5, the system timer count begins an increment transition. In the diagram, the system timer count transitions to 0x0001. On each subsequent rising edge of the system timer clock, the system timer count increments. The least significant bit (LSB) 940 of the system timer count transitions or toggles on each rising edge of the system timer clock. In the timing diagram, the rising edge of the system timer clock at timestamp 5 causes the LSB to transition from 0 to 1, and the rising edge of system timer clock at timestamp 13 causes the LSB to transition from 1 to 0.

The timing diagram shows a processor clock 950. Recall that the processor clock operates at a frequency that is at least four times that of the system timer clock frequency. The processor clock is shown to have a frequency that is four times the system timer clock frequency. In embodiments, a sampling logic within a processor can be triggered based on a change of state of a least significant bit (LSB) of the system timer count. Thus, the state change of the LSB at point A in the timing diagram can initiate the sampling. In order to enable the sampling, to compensate for LSB signal propagation delays, to buffer the LSB, and so on, delays can be introduced to the LSB. In the signal diagram, a delay_lsb signal 960 is shown. The delay can be accomplished using a delay station. Embodiments can include inserting one or more D flip-flops. The D flip-flops can be used to delay the LSB signal by a number of processor clock cycles. The D flip-flops can include a static circuit, a dynamic circuit, and so on. In embodiments, the one or more D flip-flops can be metastable.

The timing diagram can include a sync_enable signal 970. In embodiments, the sampling logic can include creating a sync_enable signal, wherein the creating can include an XOR logic element, and wherein the sync_enable signal can allow the system timer count to be latched by the first processor. Recall that an XOR logic element, such as a 2-input XOR, produces an output of 0 when the inputs are equal, and an output of 1 when only one of the inputs is equal to 1. The delay that is introduced between the LSB and the delayed LSB can be used to generate an output pulse using the XOR. In a usage example, the LSB and the delayed LSB are equal to 0. When the LSB transitions from 0 to 1, the output of the XOR transitions from 0 to 1. When the delay_lsb signal arrives at least two processor cycles later, the output of the XOR transitions from 1 to 0. The sync_enable signal enables sampling, by the sampling logic, the system timer count. The sampled system timer count can update the local system timer count 980. Thus, the system timer count is updated to the current system timer count.

Two usage examples follow. The associated signal transitions are marked with letters. In the first usage example, the LSB 940 transitions from 0 to 1 at A. The rising edge of the processor clock 950 enables the delay_lsb signal 960 to transition from 0 to 1 at C two processor clock cycles later at B. The sync_enable signal 970 transitions from 0 to 1 at D, and transitions from 1 to 0 at E, one processor cycle later. The sync_enable signal enables sampling of the system timer count by the sampling logic within the processor. The sampling enables updating of the local system timer count 980 (e.g., the local copy within the processor) to be updated. The local system timer count is updated from 0x0000 to 0x0001. In a second usage example, the falling edge of the LSB occurs at G as the system timer count 930 again increments. Two processor clock cycles later at H, the delay_lsb signal transitions from 1 to 0 at I. The sync_enable signal transitions from 0 to 1 at J, and then, one processor cycle later, transitions from 1 to 0 at K. After one processor cycle, the local system timer count updates. The local system timer count is updated from 0x0001 to 0x0002.

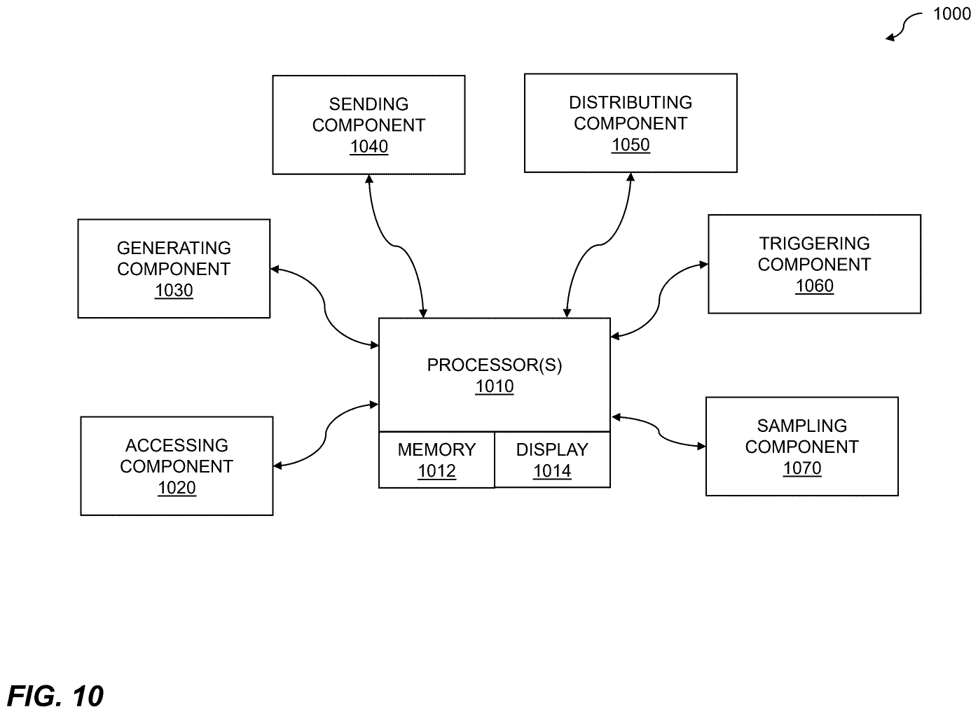

FIG. 10 is a system diagram for system time clock synchronization on an SOC with LSB sampling. The system can comprise a processor-implemented system for synchronization. The synchronization comprises system clock synchronization. The computer system can be based on semiconductor logic. The system can include one or more of processors, memories, cache memories, queues, displays, and so on. The system can include a system-on-a-chip (SOC) comprising compute clusters, where the compute clusters include one or more processors. The system 1000 can include one or more processors 1010. The processors can include standalone processors within integrated circuits or chips, processor cores in FPGAs or ASICs, one or more compute clusters within an SOC, two or more processor cores within a multiprocessor, and so on. The one or more processors 1010 are coupled to a memory 1012 which stores instructions, operations, system timer counts, snoop vectors, local snoop vectors, directional snoop vectors, and so on. The memory can include one or more of local memory, shared cache memory, shared hierarchical cache memory, system memory such as shared system memory, etc. The system 1000 can further include a display 1014 coupled to the one or more processors 1010. The display 1014 can be used for displaying data, instructions, operations, memory queue contents, various types of vectors, and the like. The operations can include system time clock synchronization operations, snoop operations, and snoop operation responses. The operations can further include cache maintenance operations, Advanced extensible Interface (AXI™) Coherence Extensions (ACE™) cache transactions, Advanced Microcontroller Bus Architecture (AMBA™) Coherence Hub Interface (CHI™) transactions, etc.

In embodiments, one or more processors 1010 are coupled to the memory 1012, wherein the one or more processors, when executing the instructions which are stored, are configured to: access a system-on-a-chip (SOC), wherein the SOC includes a system timer and one or more compute clusters, wherein each of the one or more compute clusters includes one or more processors, wherein each of the one or more processors includes an internal processor clock; generate, by the system timer, a system timer count, wherein the generating is based on a system timer clock, and wherein the system timer clock is slower in frequency than every internal processor clock within the one or more processors within the one or more compute clusters within the SOC; send, by the system timer, to each of the one or more compute clusters, the system timer count; distribute, by each of the one or more compute clusters, the system timer count to the one or more processors within the one or more compute clusters; trigger a sampling logic within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count; and sample, by the sampling logic within the first processor, the system timer count, wherein the sampling occurs after a minimum of two cycles of the first processor clock, following the triggering, and wherein the sampling obtains a current value of the system timer count.

The system 1000 can include an accessing component 1020. The accessing component 1020 can access a system-on-a-chip (SOC). An SOC can include a variety of elements associated with a computing system such as one or more processor cores, input/output interfaces, local memory, memory interfaces, secondary memory interfaces, and so on. In embodiments, the one or more compute clusters can include an interrupt engine. The interrupt engine can be used to initiate interrupts, where the interrupts can be based on shared memory access requests, missing data errors, processing errors, and so on. The interrupt engine can be used for triggering, sampling, and so on (discussed below). The interrupt engine can be associated with transmitting a system timer count (discussed below). The SOC includes a system timer and one or more compute clusters. The system timer can synchronize operations across the SOC. Each of the one or more compute clusters includes one or more processors. The processors can include homogeneous processors, heterogeneous processors, multiprocessors, etc. Each of the one or more processors includes an internal processor clock. The internal processor clock coordinates operations within its associated processor. The SOC can further include elements such as radio frequency (RF) components, graphics processors, network-on-a-chip (NOC) connectivity, etc. The SOC can be based on one or more chips, FPGAs, ASICs, etc. In embodiments, the processor cores associated with the SOC can include RISC-V™ processor cores. Memory such as local memory within the SOCs includes a local cache. The local cache can include a shared local cache. The shared local cache that can be colocated with other elements associated with the SOC, can be accessible by a processor core within the SOC, and so on. The processor cores can implement special cache coherency operations. The cache coherency operations can include maintenance operations such as cache maintenance operations (CMOs). The cache coherency operations can include a cache line zeroing operation, a cache line cleaning operation, a cache line flushing operation, a cache line invalidating operation, and so on.

The system 1000 can include generating component 1030. The generating component 1030 can generate, by the system timer, a system timer count. The system timer count can include a value such as an integer value. The system timer count can be represented by a binary value, a decimal value, a hexadecimal value, and so on. The generating is based on a system timer clock. The system timer clock can include a counter that includes a number of bits. The counter can be based on a free-running counter element, where counting continues while the counter element is enabled. In embodiments, the system timer count can include a 64-bit value. The system timer count could also include a 32-bit value, a 128-bit value, etc. The system timer count can be updated. Embodiments can include incrementing the system timer count. The system timer can further be set, reset, and so on. The system timer clock is slower in frequency than every internal processor clock within the one or more processors within the one or more compute clusters within the SOC. The slower frequency system timer clock can accommodate differing internal processor clock speeds, differing signal propagation times, and the like. The system timer clock frequency can be determined. Further embodiments include determining a frequency of the system timer clock. The system timer clock can be determined based on one or more frequencies associated with the internal processor clock speeds. In embodiments, the frequency of the system timer clock conforms to: f<C/4, wherein f is the frequency of the system timer clock and Cis a slowest processor clock within the one or more processors included in the one or more compute clusters within the SOC.

The system 1000 can include a sending component 1040. The sending component 1040 can send, by the system timer, to each of the one or more compute clusters, the system timer count. The sending can be accomplished using an interconnect such as a shared bus within the SOC. The sending can be accomplished using one or more networking techniques. In embodiments, the sending is accomplished using a network-on-a-chip (NOC). The NOC can accommodate network communications between processors within a compute cluster, between compute clusters, and so on. The NOC can include an M×N mesh topology which can include a tile such as a coherent tile at each point of the M×N mesh topology. In embodiments, the system timer count is sent in a binary format. This sending technique differs from traditional techniques that require the binary code to be converted from a binary format to a Gray code. The Gray code format was then reconverted back to the binary format. The method described herein obviates the need for the two conversions by relying on a change of state of a least significant bit (LSB) of the system timer count (described below).

The system 1000 can include a distributing component 1050. The distributing component 1050 can distribute, by each of the one or more compute clusters, the system timer count to the one or more processors within the one or more compute clusters. The system timer count can be distributed using one or more buses, an NOC, and so on. Embodiments can include transmitting, by the interrupt engine, the system timer count to the one or more processors in the first compute cluster. The interrupt engine can interrupt execution by the one or more processors within the first compute cluster while the system timer count is distributed to the processors. Since the distributing the system timer count can encounter various delays associated with the processors, one or more delays may be added to compensate for the various propagation and distributing delays. In embodiments, the transmitting can include adding one or more delay stations. The delay stations can be used to coordinate arrival of the timer count distributed to the processors within the compute clusters. In embodiments, the one or more delay stations can include a D flip-flop. Various circuit topologies can be used to implement one or more D flip-flops. In embodiments, the one or more D flip-flops can be metastable.

The system 1000 can include a triggering component 1060. The triggering component 1060 can trigger a sampling logic within a first processor within the one or more processors. The sampling logic can sample the system timer count that was distributed by each of the one or more compute clusters to the one or more processors within the compute clusters. The first processor is located within a first compute cluster within the one or more compute clusters. The first processor includes a first processor clock. The frequency associated with the first processor clock can be a frequency appropriate to the first processor. The first processor clock frequency is at least four times the system timer clock frequency. The triggering can be accomplished using a flag, a semaphore, a control signal, and so on. The triggering is based on a change of state of a least significant bit (LSB) of the system timer count. The change in state of the LSB can include a change from a zero value to a one value, or a one value to a zero value. The changing state can be associated with a rising edge of the LSB or a falling edge of the LSB. Embodiments can include producing a delay_lsb signal, wherein the delay_lsb signal includes buffering, by one or more D flip-flops, the LSB of the system timer count. The delay can be used for synchronization, retiming, LSB signal integrity restoration, etc.

The system 1000 can include a sampling component 1070. The sampling component 1070 can sample, by the sampling logic within the first processor, the system timer count. The system timer count can be sampled from a bus, from the NOC, and so on. The sampling occurs after a minimum of two cycles of the first processor clock, following the triggering. The minimum two cycles enable the first processor to capture the system timer count. The sampling obtains a current value of the system timer count and enables loading that count into a local system timer count. The sampling the system timer count enables synchronization of process execution across the one or more processors within the one or more compute clusters. A variety of circuit topologies can be used to implement the sampling logic. In embodiments, the sampling logic includes creating a sync_enable signal, wherein the creating includes an XOR logic element. The sync_enable signal can be enabled and then disabled after a delay. The enabling and disabling the sync_enable signal can resemble a “glitch” in that the sync_enable signal resets itself after a delay. The sync_enable signal allows the system timer count to be latched by the first processor. The sampling can occur on a clock edge. In embodiments, the sampling can occur on a positive clock edge of the first processor clock. The sampling can also occur on a negative clock edge of the first processor clock.

Discussed previously, every processor within every compute cluster can capture the system timer count. Embodiments can include capturing, by every processor within the one or more processors included in the one or more compute clusters within the SOC, the system timer count within one cycle of the system timer clock. The capturing the system timer count by the processors within the compute clusters included in the SOC within one clock cycle enables synchronization of the processors and the compute clusters by the system in which the SOC operates. In embodiments, the triggering and the sampling can include one or more additional processors within the first compute cluster. The triggering can be based on the LSB of the system timer count, and the sampling can be accomplished by the sampling logic within each processor. In embodiments, the sampling logic can be shared between two or more processors. In other embodiments, the triggering and the sampling can include one or more additional processors within a second compute cluster within the one or more compute clusters. The triggering and the sampling can enable system synchronization between the first compute cluster and the second compute cluster. The triggering and the sampling can include one or more additional processors within one or more further compute clusters.

The system 1000 can include a computer program product embodied in a non-transitory computer readable medium for instruction execution, the computer program product comprising code which causes one or more processors to generate semiconductor logic for: accessing a system-on-a-chip (SOC), wherein the SOC includes a system timer and one or more compute clusters, wherein each of the one or more compute clusters includes one or more processors, wherein each of the one or more processors includes an internal processor clock; generating, by the system timer, a system timer count, wherein the generating is based on a system timer clock, and wherein the system timer clock is slower in frequency than every internal processor clock within the one or more processors within the one or more compute clusters within the SOC; sending, by the system timer, to each of the one or more compute clusters, the system timer count; distributing, by each of the one or more compute clusters, the system timer count to the one or more processors within the one or more compute clusters; triggering a sampling logic within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count; and sampling, by the sampling logic within the first processor, the system timer count, wherein the sampling occurs after a minimum of two cycles of the first processor clock, following the triggering, and wherein the sampling obtains a current value of the system timer count.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Disclosed embodiments are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for synchronization comprising:
accessing a system-on-a-chip (SOC), wherein the SOC includes a system timer and one or more compute clusters, wherein each of the one or more compute clusters includes one or more processors, wherein each of the one or more processors includes an internal processor clock;
generating, by the system timer, a system timer count, wherein the generating is based on a system timer clock, and wherein the system timer clock is slower in frequency than every internal processor clock within the one or more processors within the one or more compute clusters within the SOC;
sending, by the system timer, to each of the one or more compute clusters, the system timer count;
distributing, by each of the one or more compute clusters, the system timer count to the one or more processors within the one or more compute clusters;
triggering a sampling logic within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count; and
sampling, by the sampling logic within the first processor, the system timer count, wherein the sampling occurs after a minimum of two cycles of the first processor clock, following the triggering, and wherein the sampling obtains a current value of the system timer count.

2. The method of claim 1 further comprising producing a delay_lsb signal, wherein the delay_lsb signal includes buffering, by one or more D flip-flops, the LSB of the system timer count.

3. The method of claim 2 wherein the one or more D flip-flops are metastable.

4. The method of claim 2 wherein the sampling logic includes creating a sync_enable signal, wherein the creating includes an XOR logic element, and wherein the sync_enable signal allows the system timer count to be latched by the first processor.

5. The method of claim 1 further comprising determining a frequency of the system timer clock, wherein the frequency of the system timer clock conforms to: f<C/4, wherein f is the frequency of the system timer clock and Cis a slowest processor clock within the one or more processors within the one or more compute clusters within the SOC.

6. The method of claim 1 further comprising inserting one or more delay stations.

7. The method of claim 6 wherein the one or more delay stations comprise a D flip-flop.

8. The method of claim 1 wherein the one or more compute clusters include an interrupt engine.

9. The method of claim 8 wherein the distributing includes the interrupt engine.

10. The method of claim 9 wherein the triggering and the sampling include the interrupt engine.

11. The method of claim 9 further comprising transmitting, by the interrupt engine, the system timer count to the one or more processors in the first compute cluster.

12. The method of claim 11 wherein the transmitting includes adding one or more delay stations.

13. The method of claim 1 wherein the sampling occurs on a positive clock edge of the first processor clock.

14. The method of claim 1 further comprising capturing, by every processor within the one or more processors within the one or more compute clusters within the SOC, the system timer count within one cycle of the system timer clock.

15. The method of claim 1 wherein the triggering and the sampling include one or more additional processors within the first compute cluster.

16. The method of claim 1 wherein the triggering and the sampling include one or more additional processors within a second compute cluster within the one or more compute clusters.

17. The method of claim 1 wherein system timer count comprises a 64-bit value.

18. The method of claim 17 further comprising incrementing the system timer count.

19. A computer program product embodied in a non-transitory computer readable medium for instruction execution, the computer program product comprising code which causes one or more processors to generate semiconductor logic for:
accessing a system-on-a-chip (SOC), wherein the SOC includes a system timer and one or more compute clusters, wherein each of the one or more compute clusters includes one or more processors, wherein each of the one or more processors includes an internal processor clock;
generating, by the system timer, a system timer count, wherein the generating is based on a system timer clock, and wherein the system timer clock is slower in frequency than every internal processor clock within the one or more processors within the one or more compute clusters within the SOC;
sending, by the system timer, to each of the one or more compute clusters, the system timer count;
distributing, by each of the one or more compute clusters, the system timer count to the one or more processors within the one or more compute clusters;
triggering a sampling logic within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count; and
sampling, by the sampling logic within the first processor, the system timer count, wherein the sampling occurs after a minimum of two cycles of the first processor clock, following the triggering, and wherein the sampling obtains a current value of the system timer count.

20. A computer system for instruction execution comprising:
a memory which stores instructions;
one or more processors coupled to the memory wherein the one or more processors, when executing the instructions which are stored, are configured to:
access a system-on-a-chip (SOC), wherein the SOC includes a system timer and one or more compute clusters, wherein each of the one or more compute clusters includes one or more processors, wherein each of the one or more processors includes an internal processor clock;
generate, by the system timer, a system timer count, wherein the generating is based on a system timer clock, and wherein the system timer clock is slower in frequency than every internal processor clock within the one or more processors within the one or more compute clusters within the SOC;
send, by the system timer, to each of the one or more compute clusters, the system timer count;
distribute, by each of the one or more compute clusters, the system timer count to the one or more processors within the one or more compute clusters;
trigger a sampling logic within a first processor within the one or more processors, wherein the first processor is located within a first compute cluster within the one or more compute clusters, wherein the first processor includes a first processor clock, and wherein the triggering is based on a change of state of a least significant bit (LSB) of the system timer count; and
sample, by the sampling logic within the first processor, the system timer count, wherein the sampling occurs after a minimum of two cycles of the first processor clock, following the triggering, and wherein the sampling obtains a current value of the system timer count.
